(19) United States
(12) Patent Application Publication
(10) Pub. No.: US 2008/0159577 A1
(43) Pub. Date: Jul. 3, 2008

(54) Radio Cable Assembly

(76) Inventor: Richard C. Smith, Costa Mesa, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/618,344

(22) Filed: Dec. 29, 2006

(51) Int. Cl. H04R 11/04; H04R 1/02

(52) U.S. Cl. 381/361; 381/386

(57) ABSTRACT

A radio system for use by police officers, firemen, soldiers and the like is disclosed. The radio system has a portable two-way radio, a microphone, a speaker, and a cable. The microphone can have a housing, a microphone transducer disposed within the housing, and a buffer disposed intermediate the microphone transducer and the housing. The speaker can have a housing formed of a substantially rigid material and a speaker transducer disposed within the housing. The cable can facilitate electrical communication between the portable two-way radio and the microphone and between the portable two-way radio and the speaker. The speaker and the microphone are configured so as to provide better and more reliable performance.

### TECHNICAL FIELD

The present invention relates generally to radio electronics. The present invention relates more particularly to a cable assembly for a portable two-way radio, such as those radios commonly used by police officers, firemen, and soldiers.

### BACKGROUND

Portable two-way radios are well known. Police officers, firemen, and soldiers commonly use portable two-way radios to communicate when performing their duties. Such two-way radios may be used either with their built-in microphone and speaker or with an external microphone and/or speaker. Some external microphones and speakers can be used to facilitate covert operations and can make the radio easier to use. They can also be advantageous in noisy environments.

Covert operations can be facilitated because some external microphones and speakers are less obtrusive. Their use can be less apparent, especially to casual observers. For example, an external microphone can be placed under a user's lapel and an external speaker can be placed in or near a user's ear. The user can then talk discretely to transmit a radio signal and can listen to the radio without the knowledge of others.

The microphone can either be always on, voice actuated, or controlled with a push-to-talk switch. It may be beneficial to have the microphone always on in situations where it is desired to hear all sounds proximate the user. For example, it may be beneficial to hear (and possibly record) the conversations of others. It may also be beneficial to have the microphone always on so as to avoid the need to key the microphone, which may undesirably alert others that a radio is being used. Voice actuation can alternatively be used when it is undesirable to key the microphone.

External microphones, speakers and push-to-talk switches can be electrically connected to the two-way radio via a cable assembly. The cable assembly can be an in-line cable assembly that minimizes the number of separate cables and simplifies routing and use. For example, a single cable (which may have a plurality of separate, interconnected segments) can run from the portable two-way radio to the speaker. A microphone can be attached to a shorter cable that branches off of the main cable. A push-to-talk switch can similarly be attached to a shorter cable that branches off of the main cable.

Although such portable two-way radios have proven generally suitable for their intended purposes, they possess inherent deficiencies which detract from their overall effectiveness and desirability. For example, the speakers of contemporary radio cable assemblies are attached to the cable via shrink wrap. Shrink wrap affords very limited protection to the speaker and thus leaves the speaker susceptible to damage. Damage to the speaker of a contemporary radio cable assembly can occur when the speaker is subjected to adverse situations in police operations, firefighting operations, and on the battlefield. Such adverse situations include physical abuse and environmental conditions such as exposure to moisture, dust, mold, and other contaminants. Damage to the speaker can render it incapable of adequately reproducing speech.

Further, the environments of police operations, firefighting operations, and the battlefield tend to be noisy and have substantial vibration. Such noise and vibration can adversely affect the performance of a portable two-way radio's microphone by introducing sound that interferes with the desired transmission of speech. This interference can make the user's speech at least somewhat, if not completely, unintelligible.

As those skilled in the art will appreciate, the inability to communication via a portable two-way radio in police operations, firefighting operations, and on the battlefield can have life threatening consequences. Therefore, it is desirable to provide a portable two-way radio system that has enhanced reliability. More particularly, it is desirable to provide a radio cable assembly that has a speaker with mitigated susceptibility to damage and to provide a microphone with mitigated susceptibility to ambient noise and vibration.

### BRIEF SUMMARY

Systems and methods are disclosed herein to provide a radio system for use by police officers, firemen, soldiers and the like. For example, in accordance with an embodiment of the present invention, a speaker for a radio cable assembly comprises a housing formed of a substantially rigid material and a speaker transducer disposed within the housing. The housing can be formed of aluminum. Alternatively, the housing can be formed of another durable, substantially rigid material such as titanium, another metal, an alloy, or a polymer. A ferrule can be used to seal the housing to a radio cable. A sound limiting circuit can limit a volume and/or frequencies of sound produced by the transducer.

In accordance with an embodiment of the present invention, a microphone for a radio cable comprises a housing, a microphone transducer disposed within the housing, and a buffer disposed intermediate the microphone transducer and the housing. The buffer can substantially surround the microphone transducer. The buffer can be comprised of a polymer material, such as rubber.

In accordance with an embodiment of the present invention, a radio cable assembly comprises a speaker and/or a microphone. The speaker can comprise a housing formed of a substantially rigid material and a speaker transducer disposed within the housing. The microphone can comprise a housing, a microphone transducer disposed within the housing, and a buffer disposed intermediate the microphone transducer and the housing. A cable can facilitate electrical communication between a portable two-way radio and the microphone and between the portable two-way radio and the speaker. The radio cable assembly can further comprise a push-to-talk switch in electrical communication with the cable for effecting radio transmissions.

In accordance with an embodiment of the present invention, a radio system comprises a portable two-way radio, a cable, and a microphone and/or a speaker. The microphone can comprise a housing, a microphone transducer disposed within the housing, and a buffer intermediate the microphone transducer and the housing. The speaker can comprise a housing formed of a substantially rigid material and a speaker transducer disposed within the housing. The cable can facilitate electrical communication between the portable two-way radio and the microphone and can facilitate electrical communication between the portable two-way radio and the speaker.

In accordance with an embodiment of the present invention, a method for manufacturing a speaker for a radio cable assembly comprises providing a housing formed of a substantially rigid material and mounting a speaker transducer within the housing.

In accordance with an embodiment of the present invention, a method for manufacturing a microphone for a radio cable assembly comprises providing a housing and mounting a microphone transducer within the housing such that a buffer is disposed intermediate the microphone transducer and the housing.

In accordance with an embodiment of the present invention, a method for manufacturing a radio cable assembly comprises electrically connecting a speaker to a cable, wherein the speaker comprises a housing formed of a substantially rigid material and a speaker transducer disposed within the housing. The cable is configured to facilitate electrical communication between a portable two-way radio and the speaker.

In accordance with an embodiment of the present invention, a method for manufacturing a radio cable assembly comprises electrically connecting a microphone to a cable. The microphone comprises a housing, a microphone transducer disposed within the housing, and a buffer intermediate the microphone transducer and the housing. The cable is configured to facilitate electrical communication between a portable two-way radio and the microphone.

In accordance with an embodiment of the present invention, a method for using a portable two-way radio comprises connecting a radio cable assembly to a two-way radio. The radio cable assembly comprises a speaker and/or a microphone. The speaker can comprise a housing formed of a substantially rigid material and a speaker transducer disposed within the housing, wherein the cable is configured to facilitate electrical communication between a portable two-way radio and the speaker. The microphone can comprise a housing, a microphone transducer disposed within the housing, and a buffer disposed intermediate the microphone transducer and the housing, wherein the cable is configured to facilitate electrical communication between a portable two-way radio and the microphone.

Benefits include a more durable and reliable speaker, as well as a microphone that is less susceptible to ambient noise and vibration. Enhancing the reliability of the speaker makes it more likely that the speaker will work properly when needed. As those skilled in the art will appreciate, the failure of a speaker of a portable two-way radio can have life threatening consequences, such as when the portable two-way radio is used in police operations, firefighting operations, and in the battlefield. Making the microphone less susceptible to ambient noise and vibration can enhance the microphones reliability with similar important benefits. Making speech clearer and more easily understood can mean the difference between life and death in police operations, firefighting operations, and in the battlefield.

This invention will be more fully understood in conjunction with the following detailed description taken together with the following drawings.

### BRIEF DESCRIPTION OF THE DRAWINGS

FIG. 1 is a semi-schematic front view of the upper portion of the radio cable assembly, according to an exemplary embodiment of the present invention;

FIG. 2 is a semi-schematic enlarged cross-sectional view of the speaker of FIG. 1;

FIG. 3 is a semi-schematic enlarged view, partially in section, of the female connector of FIG. 1;

FIG. 4 is an electrical schematic of the sound limiter of FIG. 3;

FIGS. 5 and 6 are semi-schematic perspective views of the speaker upper housing of FIG. 1;

FIG. 7 is a semi-schematic cross-sectional view of the speaker upper housing of FIG. 1;

FIGS. 8 and 9 are semi-schematic perspective views of the speaker lower housing of FIG. 1;

FIG. 10 is a semi-schematic cross-sectional view of the speaker lower housing of FIG. 1;

FIG. 11 is a semi-schematic perspective view of the speaker boot;

FIG. 12 is a semi-schematic cross-sectional view of the speaker boot;

FIG. 13 is a semi-schematic front view of the upper portion of the radio cable assembly, according to an exemplary embodiment of the present invention;

FIG. 14 is a semi-schematic enlarged cross-sectional view of the microphone of FIG. 1;

FIG. 15 is a semi-schematic enlarged perspective view of the microphone buffer of FIG. 14;

FIGS. 16 and 17 are semi-schematic perspective views of the microphone upper housing of FIG. 1;

FIG. 18 is a semi-schematic cross-sectional view of the microphone upper housing of FIG. 1;

FIG. 19 is an electrical schematic of the radio cable assembly, according to an exemplary embodiment of the present invention; and

FIG. 20 is a semi-schematic view of a person wearing a radio system according to an exemplary embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

A method and system for providing enhanced radio communication to police officers, firemen, soldiers, and the like are disclosed. A radio system comprises a portable two-way radio, a microphone, a speaker, and a radio cable assembly. The microphone can have a housing, a microphone transducer disposed within the housing, and a buffer disposed intermediate the microphone transducer and the housing so as to mitigate undesirable noise. The speaker can have a speaker transducer disposed within a housing that is comprised of a substantially rigid material that enhances durability. The radio cable assembly can facilitate electrical communication between the portable two-way radio and the microphone, as well as between the portable two-way radio and the speaker.

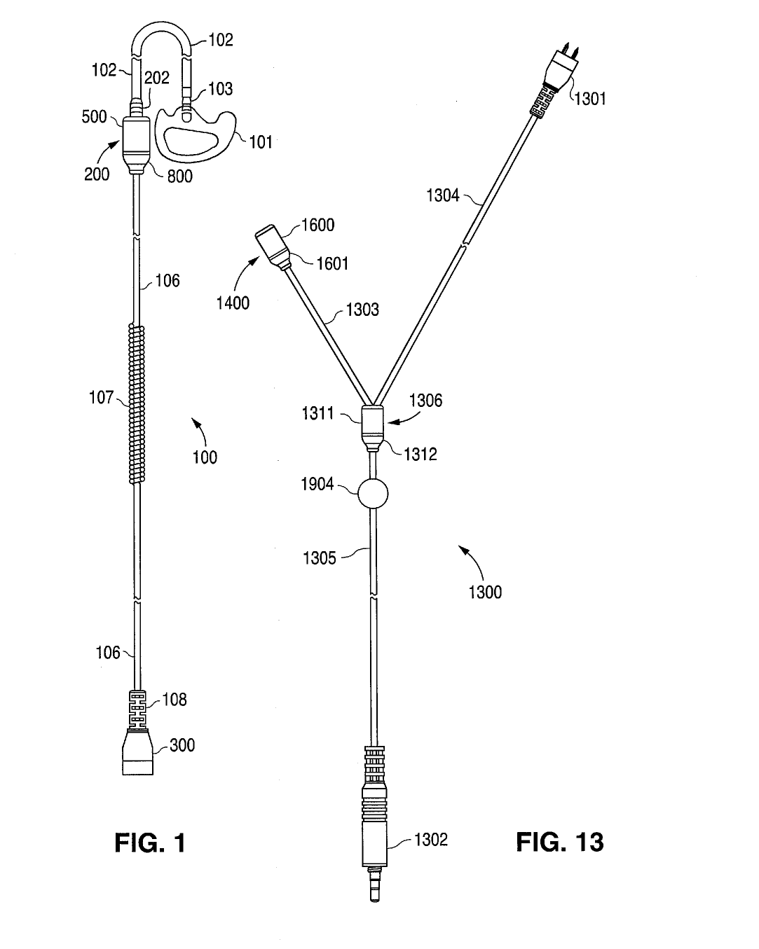

The radio cable assembly comprises an upper portion 100, as shown in FIG. 1 and a lower portion 1300, as shown in FIG. 13. Upper portion 100 can be connected to lower portion 1300, as shown in FIG. 20, to form the complete radio cable assembly.

Referring now to FIG. 1, upper portion 100 can comprise an earpiece that is configured to fit within the conchae of a user's ear so as to transmit sound (such as incoming radio transmissions) to the user's eardrum. Examples of suitable earpieces are disclosed in U.S. patent application Ser. No. 11/411,314, filed on Apr. 26, 2006, and entitled Earpiece With Extension, the entire contents of which are hereby expressly incorporated by reference.

Earpiece 101 can be attached to acoustic tubing 102, such as via barbed fitting 103. Acoustic tubing 102 can be curved so as to facilitate easy routing thereof behind the ear. Speaker 200 can be worn directly behind the ear, behind the ear at the neck, in front of the ear, in the ear, or at any other desired location. Either acoustic tubing from speaker 200 or electrical cable to speaker 200 can pass by or behind the ear. Barbed fitting 103 can be an elbow fitting.

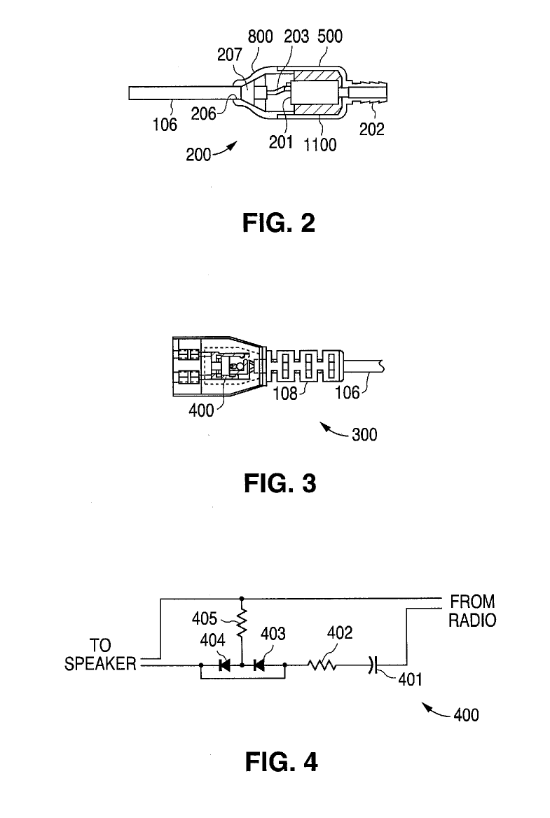

Acoustic tubing 102 can be attached to speaker 200, such as via a barbed fitting 202 (better shown in FIGS. 2 and 5-7) thereof. Speaker 200 can comprise upper 500 and lower 800 housings, as discussed in detail below. A multi-conductor electrical cable 106 can extend from speaker 200 to a connector, such as female connector 300 that electrically connects upper portion 100 of the radio cable assembly 2000 to lower portion 1300 (FIG. 13) thereof. For example, electrical cable 106 can comprise two conductors that facilitate operation of speaker 200. Strain relief 108 can be provided for electrical cable 106 at connector 300. Electrical cable 106 can comprise coils 107 that allow it to stretch as necessary to fit a particular individual.

Electrical cable 106 can provide electrical signals to speaker 800. Speaker 800 can convert such electrical signals into acoustic signals representative thereof (and generally representative of speech received from a portable two-way radio such as 2001 of FIG. 20).

Referring now to FIG. 2, a speaker housing can enclose and protect a speaker transducer 201. The speaker housing can comprise upper speaker housing portion 500 and lower speaker housing portion 800. Upper speaker housing portion 500 and lower speaker housing portion 800 can be formed of a durable, substantially rigid material. For example, upper speaker housing portion 500 and lower speaker housing portion 800 can be formed of a metal or alloy, such as a metal or alloy comprised of aluminum (anodized aluminum, for example), titanium, magnesium, or steel. Alternatively, upper speaker housing portion 500 and lower speaker housing portion 800 can be formed of a polymer, such as ABS, polycarbonate, or high density polyethylene. Upper speaker housing portion 500 can attach to lower speaker housing portion 800 via threads, friction fit, adhesive bonding, ultrasonic welding, or by any other desired method.

Speaker transducer 201 can be selected so as to provide a substantially flat (when not modified by a sound limiting circuit) and clean response. A sound limiting circuit can be used to modify the response of speaker transducer 201 so as to enhance the comfort, utility, and safety thereof. For example, the sound limiting circuit can modify the otherwise flat response so as to have dips in the response curve where objectionable noise is known to occur. That is, the sound limiting circuit can mitigate such objectionable noise.

Cable 106 enters lower housing 800 through opening 206 formed therein. Ferrule 207 can be crimped around cable 106 to hold cable 106 within the speaker housing, to provide strain relief, and/or to seal the speaker housing (such as to seal moisture, atmospheric particulates and other contaminants out of the speaker housing). A knot (not shown) can be formed in cable 106 and or conductors 203 thereof to inhibit cable 106 from being inadvertently pulled from the speaker housing.

Conductors 203 from electrical cable 106 are electrically connected to speaker transducer 201, so as to communicated speech from portable two-way radio 2001, as discussed above. Other conductors (not shown) may be used for other purposes.

Speaker transducer 201 can be generally surrounded by a boot 1100, so as to provide shock and vibration damping to speaker transducer 201. Boot 1100 can be formed of a resilient polymer material, such as rubber, and is discussed in further detail below.

Referring now to FIG. 3, connector 300 is used to attach upper cable assembly 100 to lower cable assembly 1300 (via connector 1301 of lower cable assembly 1300), as discussed above. Further, a sound limiting circuit 400 can be disposed within connector 300 so as to limit the amplitude and/or frequencies of sound communicated to the user's eardrum, as discussed in detail below. Sound limiting circuit 400 may comprise passive components, active components, or any combination thereof. Sound limiting circuit 400 may comprise discrete components formed upon a printed circuit board or may use any other desired method of packaging. Sound limiting circuit 400 may be analog, digital, or a combination of analog and digital.

Referring now to FIG. 4, sound limiting circuit 400 can be configured so as to prevent loud, annoying, distracting, and/or harmful sounds from being communicated from portable two-way radio 2001 to the user's eardrum. The amplitude and/or frequency of the sound can be controlled so as to enhance the safety, comfort, and/or utility of the radio system. For example, sound limiting circuit 400 can comprise a capacitor 401 and a resistor 402 configured as an RC network so as to provide a desired frequency response. Capacitor 401 can be a 2.2 microfarad capacitor and resistor 402 can be a 100 ohm resistor, for example.

Further, sound limiting circuit 400 can comprise a pair of diodes 403, 404 and a resistor 405 configured so as to form an amplitude limiter that shunts excessive amplitudes so that they are not transformed into acoustic energy by speaker transducer 201. Diode 403 can be SOT-23 diode, diode 404 can be a BAV199 diode, and resistor 405 can be a 10 ohm resistor, for example. Those skilled in the art will appreciate that various such sound limiting circuits can be suitable for use in various situations. For example, in situations where it is anticipated that undesirable sounds of a particular frequency may be present in the received radio signal, then sound limiting circuit 400 can be specifically configured to mitigate such sounds.

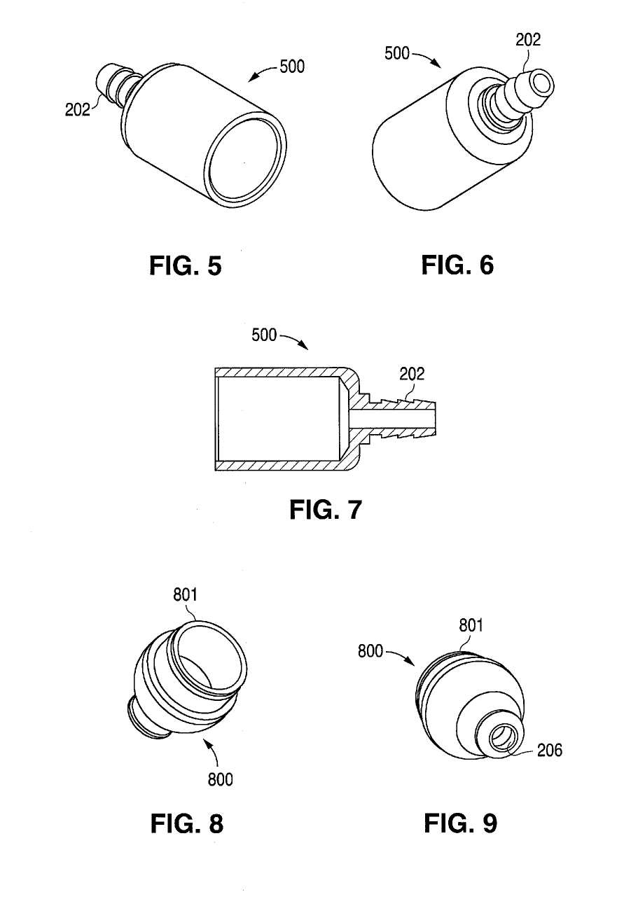

Referring now to FIGS. 5-7, the speaker housing can comprise upper housing 500 as mentioned above. Upper housing 500 can be generally cylindrical and substantially hollow. Thus, it can be configured to receive a miniature speaker, such as those commonly used with earpieces like earpiece 101. Barbed fitting 202 can extend from upper housing 500 and facilitates connection of upper housing 500 to acoustic tubing 102. Upper housing can have a diameter of approximately 8.0 mm, for example.

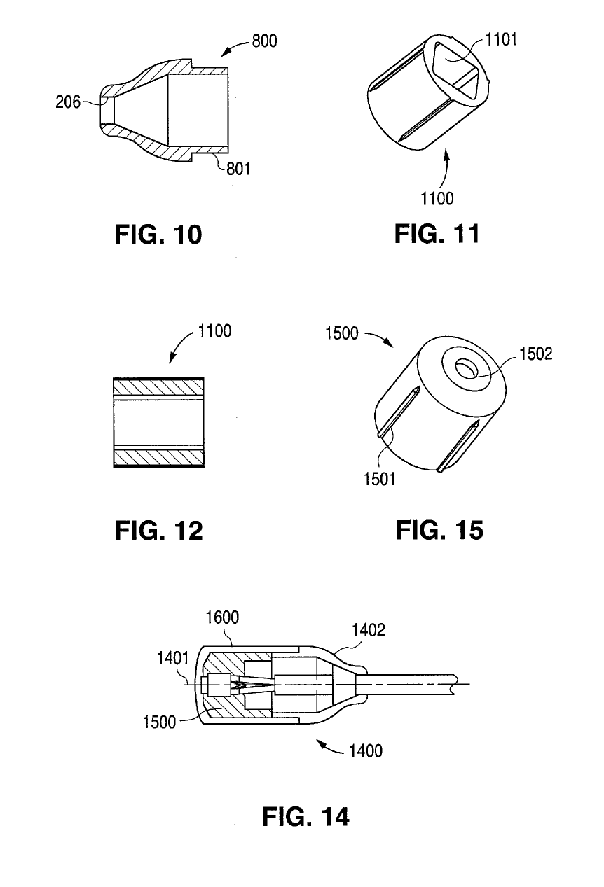

Referring now to FIGS. 8-10, the speaker housing can also comprise lower housing 800. Speaker lower housing 800 can comprise an area of reduced diameter 801 that is configured to be received within upper housing 500 (as shown in FIG. 2) so as to facilitate attachment of lower housing 800 to upper housing 500.

Referring now to FIGS. 11-12, boot 1100 can be generally cylindrical in shape and can have a diameter approximately equal to the inside diameter of upper housing 500. Boot 1100 can be formed of a resilient polymer material. Boot 1100 can have a diameter slightly greater than the inside diameter of upper housing 500, such that boot 1100 must be compressed slightly in order to insert it into upper housing 500. Boot 1101 can have a generally square opening formed therein for receiving speaker transducer 201.

Referring now to FIG. 13, lower cable assembly 1300 can comprises a microphone 1400 that is configured to attach to the user's clothing, such as proximate the user's mouth. For example, microphone 1400 can clip to the user's lapel. A connector, such as male connector 1301, can facilitate electrical connection of lower cable assembly 1300 to upper cable assembly 100 to define completer radio cable assembly 2000, as mentioned above.

A connector, such as stereo phono plug 1302, can be used to connect lower cable assembly 1300 (and consequently complete radio cable assembly 2000, to portable two-way radio 2001 (as shown in FIG. 20). Phono plug 1302 can plug directly into portable two-way radio 2001 or can plug into a side mount 2002 of radio 2001.

Cable 1303 facilitates electrical connection between microphone 1400 and connector 1302. Similarly, cable 1304 facilitates electrical connection between upper portion of cable assembly 100 and connector 1302. Cable 1303 and cable 1304 can join at Y-joint 1306 to form single cable 1305. Y-joint 1306 can comprise a housing similar in construction to the speaker housing.

More particularly, an upper Y-joint housing portion 1311 and a lower Y-joint housing portion 1312 can be formed of a durable, substantially rigid material. For example, upper Y-joint housing portion 1311 and lower Y-joint housing portion 1312 can be formed of a metal or alloy, such as a metal or alloy comprised of aluminum (anodized aluminum, for example), titanium, magnesium, or steel. Alternatively, upper Y-joint housing portion 1311 and lower portion 1312 can be formed of a polymer, such as ABS, polycarbonate, or high density polyethylene. Upper portion 1311 can attach to lower portion 1312 via threads, friction fit, adhesive bonding, ultrasonic welding, or by any other desired method.

Referring now to FIG. 14, microphone 1400 can comprise a microphone transducer 1401 generally surrounded by a buffer 1500 and disposed within a housing comprised of upper housing 1600 and lower housing 1602. Upper housing 1600 is discussed in detail below. Lower housing 1402 can be similar to speaker lower housing 800.

Buffer 1500 can comprise a vibration damping material that mitigates the undesirable transmission of ambient sound and vibration to microphone transducer 1401 and thus enhances the quality of sound transmitted by portable two-way radio 2001. Buffer 1500 can comprise a resilient polymer material.

For example, if a soldier is riding in a diesel powered armored vehicle, then engine noise can be substantial. In the absence of buffer 1500, such engine noise can be undesirably transferred through the microphone housing and to microphone transducer 1401. When the soldier attempts to transmit a radio message, the engine noise will be transmitted as well. However, buffer 1500 inhibits the transmission of engine noise (and other ambient noise) from the microphone housing to microphone transducer 1401 and thereby enhances transmission quality.

Further, the microphone housing can mitigate the undesirable generation and transmission of harmonics, thereby tending to acoustically stabilize the microphone. As those skilled in the art will appreciate, such harmonics detract from the ability of a listener to understand transmitted radio messages.

Referring now to FIG. 15, buffer 1500 can be generally cylindrical in shape and can conform in size and shape to at least a portion of the inside of the microphone housing, such as the upper housing 1600 thereof. Buffer 1500 can comprise ribs 1501. Ribs 1501 can function as standoffs that reduce the cross-sectional area of the path for sound to travel from the microphone housing though buffer 1500. That is, ribs 1501 can separate the bulk of buffer 1500 from the microphone housing. Ribs 1501 can also provide a tighter fit of buffer 1500 within the microphone housing, so as to prevent it from slipping therefrom, such as during assembly thereof. An opening 1502 can be formed in upper buffer 1500, so as to facilitate the transmission of airborne sound to microphone transducer 1401.

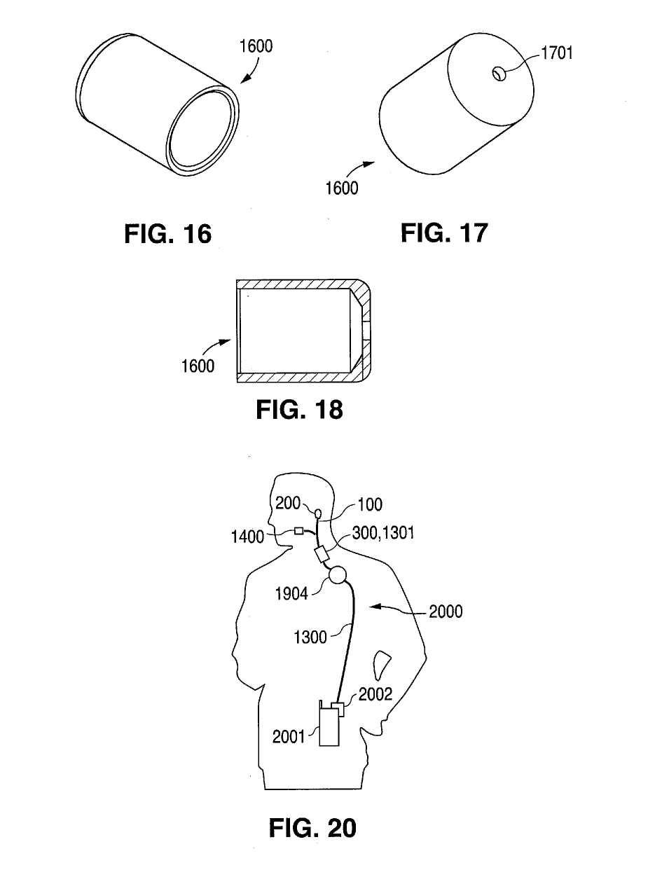

Referring now to FIGS. 16-18, microphone upper housing 1600 is generally cylindrical in shape. An opening 1701 can be formed in upper housing 1600, so as to facilitate the transmission of airborne sound to microphone transducer 1401.

Upper microphone housing portion 1600 and lower microphone housing portion 1601 can be formed of a durable, substantially rigid material. For example, upper microphone housing portion 1600 and lower microphone housing portion 1601 can be formed of a metal or alloy, such as a metal or alloy comprised of aluminum (anodized aluminum, for example), titanium, magnesium, or steel. Alternatively, upper microphone housing portion 1600 and lower microphone housing portion 1601 can be formed of a polymer, such as ABS, polycarbonate, or high density polyethylene. Upper microphone housing portion 1600 can attach to lower portion 1601 via threads, friction fit, adhesive bonding, ultrasonic welding, or by any other desired method.

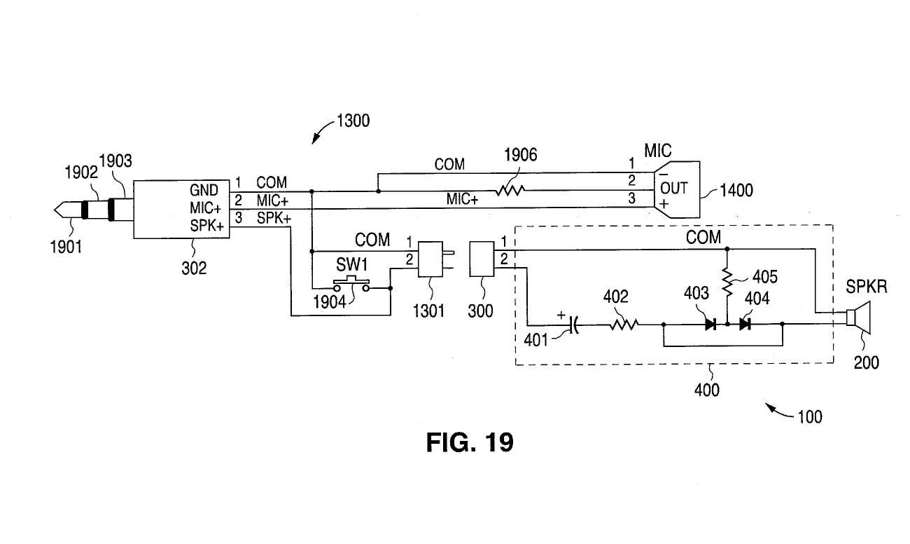

Referring now to FIG. 19, an electrical schematic of an exemplary embodiment of the radio cable assembly of the present invention is provided. A connector, such as stereo phono plug 302, facilitates electrical connection of the radio cable assembly to a portable two-way radio 2001 (as shown in FIG. 20). As discussed above, this electrical connection can be via a side mount (such as side mount 2002 of FIG. 20). Side mounts can contain impedance matching circuitry so as to enhance the performance of the microphone and/or speaker according to well known principles. Phono plug 302 can alternatively plug directly into portable two-way radio 2001, without the use of a side mount.

The use of stereo phono plug 302 provides for three separate electrical connections to portable two-way radio 2001. The tip 1901 of phone plug 302 can be used to provide electrical connection for speaker 200. The middle 1902 of phono plug 302 can be used to provide electrical connection for microphone 1400. The base 1903 of phono plug 302 can be a common conductor, e.g., ground, for both speaker 200 and microphone 1400. Other configurations of phono plug 302 and other types of connectors can alternatively be utilized.

Optionally, a push-to-talk switch 1904 can be used to facilitate transmission of radio messages according to well known principles. Alternatively, a push-to-talk switch on the portable two-way radio can be used to facilitate transmission of radio messages. As a further alternative, a voice operated switch can be used.

A resistor 1906 can be used for current limiting or impedance matching for microphone 1400. As those skilled in the art will appreciate, various other components can be used in the radio cable assembly of the present invention for a variety of different purposes.

As discussed above, male connector 1301 and female connector 300 can be used to connect lower cable portion 1300 to upper cable portion 100. Alternatively, lower cable portion 1300 and upper cable portion 100 can be formed integrally, as a one-piece cable assembly that eliminates the need for connectors 300 and 1301.

As discussed above, sound limiting circuit 400 enhances the comfort and safety of the user by modifying the electrical signal prior to the electrical signal being converted into acoustic energy. Sound limiting circuit 400 can be inside of connector 300. Alternatively, sound limiting circuit 400 can be inside of connector 1301, inside of phono plug 302, inside of the speaker 200 or at any other desired location on radio cable assembly 2000. For example, sound limiting circuit 400 can be along cable 106.

Referring now to FIG. 20, a user can wear a portable two-way radio 2001, such as at the user's waist. A side mount 2002 can be attached to radio 2001 to facilitate impedance matching for speaker 200 and microphone 1400. Radio cable assembly 2000, comprising lower cable portion 1300 and upper cable portion 100, provides electrical connection between radio 2001, push-to-talk switch 1904, microphone 1400, and speaker 200.

Thus, one or more embodiments of the present invention provide enhanced ability to communicate via a portable two-way radio in such situations as police operations, firefighting operations, and on the battlefield. As mentioned above, the ability to reliably perform such communications can have life and death consequences.

One or more embodiments of the present invention provide a portable two-way radio system and/or components thereof that have enhanced reliability. For example, one embodiment of the present invention provides a speaker having mitigated susceptibility to damage and one embodiment of the present invention provides a microphone with mitigated susceptibility to ambient noise and vibration. Use of the radio cable assembly of the present invention also allows a radio to be heard at a lower volume in a noisy environment than is generally otherwise possible.

Embodiments described above illustrate, but do not limit, the invention. It should also be understood that numerous modifications and variations are possible in accordance with the principles of the present invention. Accordingly, the scope of the invention is defined only by the following claims.

1. A speaker for a radio cable assembly, the speaker comprising:
a housing formed of a substantially rigid material; and
a speaker transducer disposed within the housing.

2. The speaker as recited in claim 1, wherein the housing is formed of aluminum.

3. The speaker as recited in claim 1, wherein the housing is formed of titanium.

4. The speaker as recited in claim 1, wherein the housing is formed of a polymer.

5. The speaker as recited in claim 1, further comprising a ferrule for sealing the housing to a radio cable.

6. The speaker as recited in claim 1, further comprising a sound limiting circuit in electrical communication with the transducer.

7. The speaker as recited in claim 1, further comprising a sound limiting circuit in electrical communication with the transducer, the sound limiting circuit being configured to limit a volume of sound produced by the transducer.

8. The speaker as recited in claim 1, further comprising a sound limiting circuit in electrical communication with the transducer, the sound limiting circuit being configured to limit frequencies of sound produced by the transducer.

9. A microphone for a radio cable assembly, the microphone comprising:
a housing;
a microphone transducer disposed within the housing; and
a buffer intermediate the microphone transducer and the housing.

10. The microphone as recited in claim 9, wherein the buffer substantially surrounds the microphone transducer.

11. The microphone as recited in claim 9, wherein the buffer is comprised of a polymer material.

12. The microphone as recited in claim 9, wherein the buffer is comprised of rubber.

13. The microphone as recited in claim 9, wherein the buffer comprises at least one rib that mitigates sound transmission therethough.

14. A radio cable assembly comprising:
a speaker, the speaker comprising:
a housing formed of a substantially rigid material;
a speaker transducer disposed within the housing; and
a cable for facilitating electrical communication between a portable two-way radio and the speaker.

15. The radio cable assembly as recited in claim 14, further comprising a microphone in electrical communication with the cable.

16. The radio cable assembly as recited in claim 14, further comprising a push-to-talk switch in electrical communication with the cable for effecting radio transmissions.

17. A radio cable assembly comprising:
a microphone, the microphone comprising:
a housing;
a microphone transducer disposed within the housing;
a buffer intermediate the microphone transducer and the housing; and
a cable for facilitating electrical communication between a portable two-way radio and the microphone.

18. The radio cable assembly as recited in claim 17, further comprising a speaker in electrical communication with the cable.

19. The radio cable assembly as recited in claim 17, further comprising a push-to-talk switch in electrical communication with the cable for effecting radio transmissions.

20. A radio system comprising:
a portable two-way radio;
a microphone comprising:
a microphone housing;
a microphone transducer disposed within the microphone housing;
a buffer intermediate the microphone transducer and the microphone housing;
a speaker comprising:
a speaker housing formed of a substantially rigid material;
a speaker transducer disposed within the speaker housing; and
a cable for facilitating electrical communication between the portable two-way radio and the microphone and for facilitating electrical communication between the portable two-way radio and the speaker.

21. A method for manufacturing a speaker for a radio cable assembly, the method comprising:
providing a housing formed of a substantially rigid material; and
mounting a speaker transducer within the housing.

22. A method for manufacturing a microphone for a radio cable assembly, the method comprising:
providing a housing; and
mounting a microphone transducer within the housing such that a buffer is disposed intermediate the microphone transducer and the housing.

23. A method for manufacturing a radio cable assembly, the method comprising:
electrically connecting a speaker to a cable, wherein the speaker comprises:
a housing formed of a substantially rigid material;
a speaker transducer disposed within the housing; and
wherein the cable is configured to facilitate electrical communication between a portable two-way radio and the speaker.

24. A method for manufacturing a radio cable assembly, the method comprising:
electrically connecting a microphone to a cable, the microphone comprising:
a housing;
a microphone transducer disposed within the housing;
a buffer intermediate the microphone transducer and the housing; and
wherein the cable is configured to facilitate electrical communication between a portable two-way radio and the microphone.

25. A method for using a portable two-way radio the method comprising connecting a radio cable assembly to a two-way radio, wherein the radio cable assembly comprises at least one of:
a speaker comprising a speaker housing formed of a substantially rigid material and a speaker transducer disposed within the speaker housing, wherein the cable is configured to facilitate electrical communication between a portable two-way radio and the speaker; and
a microphone comprising a microphone housing, a microphone transducer disposed within the microphone housing, and a buffer disposed intermediate the microphone transducer and the housing, wherein the cable is configured to facilitate electrical communication between a portable two-way radio and the microphone.
